(19) United States
(12) Patent Application Publication
(10) Pub. No.: US 2006/0148915 A1
(43) Pub. Date: Jul. 6, 2006

(54) Microporous materials and methods of making

(76) Inventors: Robert M. Floyd, Maplewood, MN (US); Randall P. Swenson, River Falls, WI (US); James S. Mrozinski, Oakdale, MN (US)

Correspondence Address: 3M INNOVATIVE PROPERTIES COMPANY, PO BOX 33427, ST. PAUL, MN, 55133-3427, US

(21) Appl. No.: 11/026,852

(22) Filed: Dec. 30, 2004

(51) Int. Cl. B32B 27/00; C08J 9/26

(52) U.S. Cl. 521/61; 428/319.3; 428/319.7; 428/317.9

(57) ABSTRACT

Microporous materials and articles are disclosed. The microporous materials contain a polyolefin or olefinic polymer and a solid diluent in which the polymer is soluble at a temperature above the melting temperature of the polymer and that phase separates from the polymer at a temperature below the polymer crystallization temperature. The resulting material is a microporous material having a polymeric matrix with solid diluent present throughout. The invention is also directed to methods of forming the microporous material using thermally induced phase separation and subsequent processing.

### FIELD OF THE INVENTION

The present invention relates to microporous materials, including microporous materials formed by crystallization of a polyolefin polymer in the presence of a diluent. The invention also relates to methods of forming microporous materials and articles made using the microporous materials.

### BACKGROUND

Microporous membranes or films have been used in a wide variety of applications, such as for the filtration of solids, for the ultrafiltration of colloidal matter, as diffusion barriers or separators in electrochemical cells, in the preparation of synthetic leather, and in the preparation of cloth laminates. Some of these applications require permeability to water vapor but not liquid water, such as when using the materials for synthetic shoes, raincoats, outer wear, camping equipment such as tents, and the like. Microporous membranes or films are often utilized for microfiltration of liquids such as antibiotics, beer, oils, bacteriological broths, as well as for the analysis of air, microbiological samples, intravenous fluids, vaccines, and the like. Microporous membranes or films are also utilized in the preparation of surgical dressings, bandages, and in other fluid or gas transmissive medical applications.

Microporous films are also used as oil removal cloths and wipes, for cosmetic purposes. Opaque prior to use, the film turns transparent or translucent upon exposure to oil, due to the oil filling the micropores.

Microporous films or membranes have a structure that enables fluids (gas, and often liquids) to flow through them or into them. Whether or not liquid will pass through the film or membrane is dependent upon the pore size of the structure and many other properties such as surface energy and chemical nature. Such sheets are generally opaque, even when made from an originally transparent material, because the surfaces and internal structure scatter visible light.

Microporous membranes or films of crystallizable thermoplastic polymers such as, for example, polyolefins, polyesters and polyamides, have been prepared using solid-liquid thermally induced phase separation techniques. See, for example, U.S. Pat. No. 4,726,989. The polymer in this technique is melt-blended with a compatible liquid such as mineral oil, is shaped and cooled under conditions to achieve thermally induced phase separation, followed by orienting, i.e., stretching the article and optionally removing the compatible liquid.

Although these known microporous materials and methods of making the microporous materials are suitable for many applications, other materials are desired. For example, materials with low or no extractable components, different oil absorption properties, different filtration properties, and different handling properties.

### SUMMARY OF THE DISCLOSURE

The present invention is directed to microporous materials suitable for use in a wide range of applications. The microporous materials contain a combination of a crystallizable polyolefin polymer and a diluent material, which are present during formation of the microporous materials and also present in the microporous materials. The diluent material is solid at room temperature at atmospheric pressure. The diluent material is miscible with the polyolefin polymer at a temperature above the melting point of the polymer, yet phase separates from the polymer as the polymer crystallizes.

The microporous materials of the invention are formed using a thermally induced phase separation (TIPS) method. The TIPS method of making the microporous materials typically includes melt blending the crystallizable polyolefin-containing polymer and the diluent to form a homogenous melt mixture or solution. The diluent, solid at room temperature, is preferably at least partially melted prior to blending with the polyolefin polymer. After creating this homogenous mixture, the mixture is formed into a shaped article and cooled to a temperature at which the polyolefin-containing polymer phase separates from the diluent. In this manner, a non-porous material is formed that comprises an aggregate of a plurality of interconnected crystallized polyolefin polymer domains combined with the solid diluent compound.

Following formation of the polymer/diluent article, the porosity of the material is obtained by stretching the article in at least one direction. This step results in separation of adjacent domains of polyolefin polymer from one another to provide a network of spherulitic domains surrounded by interconnected micropores. The micropores are present in the material without removal or extraction of the solid diluent. In some embodiments, the solid diluent material at least partially covers the polyolefin domains.

In some embodiments, a nucleating agent may be added to the homogenous melt mixture. A nucleating agent allows the microporous films to be made, and crystallized, over a broader range of conditions than are generally used. The polymer domains or spherulites that form in the presence of a nucleating agent generally have an increased number of domains or spherulites per unit volume compared to if no nucleating agent were present. When polypropylene polymer is used, it is preferred to utilize a nucleating agent.

Other features and advantages of the invention will be apparent from the following detailed description of the invention and the claims. The above summary of principles of the disclosure is not intended to describe each illustrated embodiment or every implementation of the present disclosure. The detailed description that follows more particularly exemplifies certain embodiments utilizing the principles disclosed herein. Various articles made with these systems and methods of making the articles are also described. Other features and advantages will be apparent from the following detailed description, the examples, and from the claims.

### BRIEF DESCRIPTION OF THE DRAWING

In the several figures of the attached drawing, like parts bear like reference numerals, and:

FIG. 1 is a diagrammatical view of an apparatus that may be used in the process of the invention to produce a microporous film according to the invention.

FIG. 2 is a photomicrograph of Example 1, which is a stretched microporous material made from polyethylene polymer and polyethylene wax diluent.

FIG. 3 is a photomicrograph of Example 4, which is a stretched microporous material made from polypropylene polymer and polyethylene wax diluent.

FIG. 4 is a photomicrograph of Example 9, which is a stretched microporous material made from methylpentene copolymer and paraffin wax diluent.

FIG. 5 is a graph of the % reflectance of films from Examples 10a-10g measured at a spectrum of wavelengths of incident light.

### DETAILED DESCRIPTION

As provided above, the present invention is directed to various improvements in microporous materials and methods. Overall, the improved materials are directed to various porous materials having a polyolefin polymer and a solid diluent, and methods of making.

The present invention is directed to improved microporous materials and articles comprising polyolefin and solid diluent, made using thermally induced phase separation (TIPS). The improved materials of the invention include a crystallizable polyolefin polymer plus a solid diluent.

The articles and materials of the present invention have a microporous structure characterized by a multiplicity of spaced (i.e., separated from one another), randomly dispersed domains of polyolefin polymer connected by fibrils and solid diluent material. This structure provides for advantageous porosity, strength, and stretchability of the microporous materials.

Various terms are used in the specification and claims herein that may require explanation beyond their generally understood meanings.

Thus, it will be understood that, when referring to the polyolefin polymer or polyolefin-containing polymer as being “crystallized,” this means that it is at least partially crystalline.

It will be further understood that the term “thermoplastic polymer” refers to conventional polymers that are melt processable under ordinary melt processing conditions. The term “thermoplastic polymer” is not intended to include polymers that may be thermoplastic but are rendered melt processable only under extreme conditions.

The term “diluent” refers to a material that (1) is mixable with a polymeric material, (2) is able to form a solution with a polymeric material when the mixture is heated above the melt temperature of the polymeric material, and (3) phase separates from that solution when the solution is cooled below the crystallization temperature of the polymeric material.

The term “solid diluent” refers to a diluent that is solid at room temperature, and solid up to at least about 50° C. That is, the melting temperature of the diluent is above 50° C., and preferably above 60° C.

The term “melting temperature” refers to the temperature at which the material, whether the polymer, diluent, or combination thereof, will melt.

The term “crystallization temperature” refers to the temperature at which the polymer, when present with diluent in the blend, will crystallize.

The term “melting point” refers to the commonly accepted melting temperature of the pure polymer, as may be available in published references.

The microporous material of the present invention has various benefits over previous microporous materials, particularly those made with liquid diluents, such as oil. A desired characteristic of microporous films and membranes is the ability to hold a fold, crease, or otherwise crumple the film or membrane into a tight ball. Microporous films and membranes made from polymeric material and oil generally are unable to hold a crease or crumple. That is, the oil containing materials having a tendency to unfold.

Microporous films and membranes made with solid diluent can be embossed with a pattern during the TIPS process or after the material has been made. The materials generally permanently retain the embossed pattern. In some embodiments, the embossed pattern may collapse or seal a portion of the micropores in the material, creating a transparent or translucent area in the material at those locations.

Additionally, microporous materials according to the invention are highly diffusive, reflecting visible light at much higher levels than microporous materials made from polymeric material and containing liquid diluent. It is believed that the efficiency of the materials as a diffuse reflector is increased because of the additional refractive index change, or morphology features, provided by the solid diluent, which are typically not found with liquid diluent phase separating systems.

Still further, microporous materials made with solid diluent have less extractable components, which could leach out or be extracted from the material. The solid diluent is less mobile within the material or upon the material surface than liquid diluents. Solid diluent microporous materials are particularly suited for filtration applications, where the amount of contamination in the filtrate is preferably minimized.

The microporous materials of the invention contain a combination of a crystallizable polyolefin polymer and a solid diluent material, which are present during formation of the microporous materials and also present in the microporous materials. The diluent material is solid at room temperature at atmospheric pressure. The diluent material is miscible with the polyolefin polymer at a temperature above the melting point of the polymer, yet phase separates from the polymer as the polymer crystallizes. When the polyolefin polymer cools below its crystallization temperature, the polymer regions separate from the diluent to form a material having a continuous polymer phase and a diluent phase. The specific ingredients of the microporous material, as well as methods of making the material will now be discussed in additional detail.

Polyolefin Polymer

The polymer component of the microporous articles is a crystallizable polyolefin or polyolefin-containing material. “Polyolefin” refers to a class of thermoplastic polymers derived from olefins, also commonly referred to as alkenes, which are unsaturated aliphatic hydrocarbons having one or more double bonds. Common polyolefins include polyethylene, polypropylene, polybutenes, polyisoprene, and copolymers thereof. “Polyolefin-containing” refers to polyolefin copolymers containing polyolefin or olefin mer units, and mixtures of thermoplastic polymers that include polyolefin. The polyolefin polymer is selected such that it provides good TIPS functionality while having suitable properties in the finished article, such as strength and handleability.

The microporous articles contain at least about 25 wt-% crystallizable polyolefin-containing polymer, and no more than about 75 wt-%. Typically, the articles contain about 30 to 70 wt-% polymer, and preferably about 35 to 65 wt-% polymer. The level of polyolefin in the microporous article will largely depend upon the specific polyolefin material used, as will be described in detail below.

Crystallizable thermoplastic polymers suitable for use in a polymer mixture that includes polyolefin are typically melt processable under conventional processing conditions. That is, upon heating, they will easily soften and/or melt to permit processing in conventional equipment, such as an extruder, to form a sheet. Crystallizable polymers, upon cooling under controlled conditions, spontaneously form geometrically regular and ordered crystalline structures. Preferred crystallizable polymers for use in the present invention have a high degree of crystallinity and also possess a tensile strength greater than about 70 kg/cm² or 1000 psi.

Examples of suitable crystallizable thermoplastic polyolefin polymers include polyolefins such as polyethylene (including high-density and low-density), polypropylene, polybutenes, polyisoprene, and copolymers thereof. Many useful polyolefins are polymers of ethylene, but also may include copolymers of ethylene with 1-octene, styrene, and the like.

As mentioned above, the level of polyolefin in the microporous articles will largely depend upon the specific polyolefin material used. The level of polyolefin will also depend upon the specific diluent material used. For example, microporous articles incorporating high-density polyethylene (HDPE) typically contain 25 to 50 wt-% HDPE, preferably 30 to 40 wt-% HDPE, but again, based largely upon the diluent used. As another example, microporous articles incorporating polypropylene (PP) typically contain 30 to 75 wt-% PP, preferably 35 to 65 wt-% PP, but again, based largely upon the diluent used. And as yet another example, microporous articles incorporating methylpentene copolymer (TPX) typically contain 35 to 55 wt-% TPX, preferably 40 to 45 wt-% TPX, but again, based largely upon the diluent used.

Solid Diluent Compound

The polyolefin polymer is combined with a diluent compound to provide the microporous material. Diluent compounds suitable for blending with the crystallizable polyolefin-containing polymer to make the microporous materials of the present invention are materials in which the crystallizable polymer will dissolve or solubilize to form a solution at or above the melting temperature of the crystallizable polymer and the diluent, but will phase separate upon cooling at or below the crystallization temperature of the crystallizable polymer and the diluent.

Most often, the solid diluent is a wax. The term “wax” is applied to a large number of chemically different materials. Waxes are generally solid at room temperature (20° C.) and melt at temperatures greater than about 50° C. Waxes are thermnoplastic in nature. In the most general terms, waxes are “naturally” or “synthetically” derived. Natural waxes include animal waxes (such as beeswax, lanolin, tallow), vegetable waxes (such as camauba, candelilla, and soy), and mineral waxes such as fossil or earth waxes and petroleum (such as paraffin and microcrystalline). Synthetic waxes include ethylenic polymers and copolymers, which include polyethylenes and ethylene-propylene copolymers. These waxes are low molecular weight ethylene homopolymers, and are generally linear and saturated.

Paraffin waxes are derived from the light lubricating oil distillates. Paraffin waxes contain predominantly straight-chain hydrocarbons with an average chain length of 20 to 30 carbon atoms. Paraffin waxes are characterized by a clearly defined crystal structure and have the tendency to be hard and brittle. The melting point of paraffin waxes generally falls between about 50° C. and about 70° C.

Microcrystalline waxes are produced from a combination of heavy lube distillates and residual oils. They differ from paraffin waxes in that they have poorly defined crystalline structure, a generally darker color, and generally higher viscosity and melting points. Microcrystalline waxes tend to vary much more widely than paraffin waxes with regard to physical characteristics. Microcrystalline waxes can range from being soft and tacky to being hard and brittle, depending upon the compositional balance.

Other materials that are not necessarily waxes may also be suitable as solid diluents. For example, suitable solid diluents include low molecular weight polymers or copolymers.

The melting point of the solid diluent material is greater than room temperature, i.e., the melting point is at least about 50° C., so at room temperature (about 20° C.), the diluent is a solid material. The solid diluent is selected, for use with a specific polyolefin polymer, so that the difference in melting points of the two materials is generally at least 25° C. and preferably at least 40° C., although it is understood that materials with lesser melting point differences may be suitable. Typically, the solid diluent will have a melting point that is less than the melting point of the polymer.

Also when selecting a solid diluent for use with a specific polymer, it should be selected so that the polymer is soluble in the melted diluent. However, the polymer should not be so soluble that the melt blend does not hold its shape sufficiently to be formed into the resulting article, such as a membrane.

Specific examples of commercially available products that are suitable as solid diluents include paraffin wax under the tradeneme “IGI 1231” from International Group, Inc. (having a melting point of about 53° C.), microcrystalline waxes under the tradenames “Mulitwax W-835” from Crompton-Witco (having a melting point of about 74-80° C.), “Multiwax 180-W” (having a melting point of about 80-87° C.) and “Multiwax W-445” (having a melting point of about 77-82° C.), and low molecular weight polyethylene waxes under the tradename “Polywax 400” (having a melting point of about 81° C.) and “Polywax 500” (having a melting point of about 88° C.), from Baker Petrolite. An alternate term for low molecular weight polyethylene waxes is Fischer-Tropsch waxes, such as available from Sasol. “Sasolwax C80” is similar to Polywax 500. Another commercially available product that is suitable as a solid diluent is short chain ethylene/propylene copolymer under the tradename “EP-700” (having a melting point of about 96° C.) from Baker Petrolite.

As mentioned above, the level of solid diluent in the microporous article will largely depend upon the specific solid diluent material used. The level of solid diluent will also depend upon the specific polyolefin polymer used. Often, a higher molecular weight diluent is present at higher levels than lower molecular weight diluent.

For example, microporous articles incorporating high-density polyethylene (HDPE) typically contain 50 to 75 wt-% solid diluent, preferably 60 to 70 wt-% solid diluent, but again, based largely upon the diluent used. For example, when Polywax 400 is used in HDPE, the Polywax 400 is preferably present at a level of at least 55 wt-%, and when Polywax 500 is used, it is present at a level of at least 65 wt-%. When Crompton W-835 microcrystalline wax is used in HDPE, the wax is preferably present at a level of at least 60 wt-%. When IGI 1231 paraffin wax is used in HDPE, the wax is preferably present at a level of at least 60 wt-%.

As another example, microporous articles incorporating polypropylene (PP) typically contain 25 to 70 wt-% solid diluent, preferably 35 to 65 wt-% solid diluent, but again, based largely upon the diluent used. For example, for Polywax 400, Polywax 500, and EP-700, the solid diluent is present at a level of at least 35 wt-%, preferably about 35 to 50 wt-%. For IGI 1231 paraffin wax, the wax is preferably present at levels of 35 to 70 wt-%.

And as yet another example, microporous articles incorporating methylpentene copolymer (TPX) typically contain 45 to 65 wt-% solid diluent, preferably 55 to 60 wt-% solid diluent, but again, based largely upon the diluent used. For example, when IGI 1231 paraffin wax is used, the wax is present at a level of at least 45 wt-% and is preferably present at a level of 50 to 65 wt-%.

A particular combination of polymer and diluent may include more than one polymer, i.e., a mixture of two or more polymers and/or more than one diluent.

Optional Ingredient—Nucleating Agent

Nucleating agents are materials that may be added to the polymer melt as a foreign body. When the polyolefin polymer cools below its crystallization temperature, the loosely coiled polymer chains orient themselves about the foreign body into regions of a three-dimensional crystal pattern to form a material having a continuous polymer phase and a diluent phase.

Nucleating agents work in the presence of melt additives in the thermally induced phase separated system of the present invention. The presence of at least one nucleating agent is advantageous during the crystallization of certain polyolefin polymeric materials, such as polypropylene, by substantially accelerating the crystallization of the polymer over that occurring when no nucleating agent is present. This in turn results in a film with a more uniform, stronger microstructure because of the presence of increased number of reduced-sized domains. The smaller, more uniform microstructure has an increased number of fibrils per unit volume and allows for greater stretchability of the materials so as to provide higher void porosity and greater tensile strength than heretofore achievable. Additional details regarding the use of nucleating agents are discussed, for example, in U.S. Pat. No. 6,632,850 and in U.S. Pat. No. 4,726,989.

The amount of nucleating agent must be sufficient to initiate crystallization of the polyolefin-containing polymer at enough nucleation sites to create a suitable microporous material. This amount can typically be less than 0.1 wt-% of the diluent/polymer mixture, and even more typically less than 0.05 wt-% of the diluent/polymer mixture. In specific implementations the amount of nucleating agent is about 0.01 wt-% (100 ppm) to 2 wt-% of the diluent/polymer mixture, even more typically from about 0.02 to 1 wt-% of the diluent/polymer mixture.

Useful nucleating agents include, for example, gamma quinacridone, aluminum salt of quinizarin sulphonic acid, dihydroquinoacridin-dione and quinacridin-tetrone, triphenenol ditriazine, two component initiators such as calcium carbonate and organic acids or calcium stearate and pimelic acid, calcium silicate, dicarboxylic acid salts of metals of the Group IIA of the periodic table, delta-quinacridone, diamides of adipic or suberic acids, calcium salts of suberic or pimelic acid, different types of indigosol and cibantine organic pigments, quiancridone quinone, N′,N′-dicyclohexil-2,6-naphthalene dicarboxamide (NJ-Star NU-100, ex New Japan Chemical Co. Ltd.), and antraquinone red, phthalo blue, and bis-azo yellow pigments. Preferred agents include gamma-quinacridone, a calcium salt of suberic acid, a calcium salt of pimelic acid and calcium and barium salts of polycarboxylic acids.

The nucleating agent should be selected based on the polyolefin polymer being used. The nucleating agent serves the important functions of inducing crystallization of the polymer from the liquid state and enhancing the initiation of polymer crystallization sites so as to speed up the crystallization of the polymer. Thus, the nucleating agent may be a solid at the crystallization temperature of the polymer. Because the nucleating agent increases the rate of crystallization of the polymer by providing nucleation sites, the size of the resultant polymer domains or spherulites is reduced. When the nucleating agent is used to form the microporous materials of the present invention, greater amounts of diluent compound can be used relative to the polyolefin-containing polymer forming the microporous materials.

By including a nucleating agent, the resultant domains of olefin-containing polymer are reduced in size over the size the domains would have if no nucleating agent were used. It will be understood, however, that the domain size obtained will depend upon the additive, component concentrations, and processing conditions used. Because reduction in domain size results in more domains, the number of fibrils per unit volume is also increased. Moreover, after stretching, the length of the fibrils may be increased when a nucleating agent is used than when no nucleating agent is used because of the greater stretchability that can be achieved. Similarly, the tensile strength of the resultant microporous materials can be greatly increased. Hence, by including a nucleating agent, more useful microporous materials can be prepared than when nucleating agents are not present.

Use of a nucleating agent is preferred when using polypropylene polymer, due to the morphological structures formed by polypropylene's inherent crystalline nature during the phase separating process.

Additional Optional Ingredients

Various additional ingredients may be included in the microporous materials of the present invention. These ingredients may be added to the polymeric blend melt, may be added to the material after casting, or may be added to the material after stretching of the material, as will be described below.

Most optional ingredients are added to the polymeric blend melt, with the polyolefin polymer and the solid diluent, as melt additives. Such melt additives can be surfactants, antistatic agents, ultraviolet radiation absorbers, antioxidants, organic or inorganic colorants, stabilizers, fragrances, plasticizers, anti-microbial agents, flame retardants, and antifouling compounds, for example.

The amounts of these optional ingredients is generally no more than about 15 wt-% of the polymeric blend melt, often no more than 5 wt-%, so long as they do not interfere with nucleation or the phase separation process.

Microporous Articles

A preferred article according to the present invention is in the form of a sheet, membrane or film, although other article shapes are contemplated and may be formed. For example, the article may be in the form of a tube or filament. Other shapes that can be made according to the disclosed process are also intended to be within the scope of the invention.

The microporous materials of the present invention can be used in a wide variety of applications where microporous structures are useful. Microporous articles may be free-standing films or may be affixed to a substrate, such as structures made from materials that are polymeric, woven, nonwoven, film, foil or foam, or a combination thereof, depending upon the application, such as by lamination.

The microporous materials of the present invention can be used in a broad variety of applications, in some of which other microporous materials, made with liquid diluents, have not been used. For example, due to the tendency for the material of the present invention to remain creased or folded, microporous films may be used as the substrate for banknotes or other security documents. As another example, due to the highly diffuse nature of the material of the present invention, microporous films of the invention could be attached to metallized, multi-layer, or other reflective optical films. A laminated construction with these types of optical films allows for the inherent reflectivity performance of a specular (i.e., mirror-like) optical film but with the light scatter features imparted by the film of this invention. The diffuse reflectivity can be very effective by using a very thin porous film of the present invention in a laminated construction. Depending on the application needs, the laminated construction can be conformable or rigid. Uses for the materials of the invention include light boxes, white standards, photographic lights, electronic blackboards, backlit LCD computer screens or other screens such as for PDAs, telephones, projection display systems or televisions, solar cells, light pipes, and any device where diffuse reflectivity is desired. The microporous materials are also suitable for cosmetic use, such as oil removal wipes or blotters.

Methods for Making Microporous Articles

Production of microporous articles in accordance with the current invention requires melt blending a crystallizable polyolefin polymer and a solid diluent into a homogenous mixture or solution. The polymer is soluble in the melted solid diluent. After the materials have been melt blended, they are formed into a shape, and cooled to a temperature at which the solid diluent solidifies and the polyolefin polymer crystallizes, so as to induce phase separation between the polyolefin polymer and the solid diluent. The melted material may be filtered when shaped (e.g., extruded) to remove any impurities that might be present. In this manner an article is formed comprising an aggregate of a first phase comprising semi-crystalline polymer and a second phase of the solid diluent compound.

The polymer is present as domains of polymer. In some embodiments, these domains are spherulitic or may be spherulites or an agglomerate of spherulites; in other embodiments, the domains may have a “lacey” structure. Adjacent domains of polymer are distinct, but they have a plurality of zones of continuity. There are areas of contact between adjacent polymer domains where there is a continuum of polymer from one domain to the next adjacent domain in such zones of continuity. The polymer domains are generally surrounded or coated by the diluent, but not necessarily completely. Diluent generally occupies at least a portion of the space between domains.

A preferred form for the article is as a web, film or membrane, which is extruded.

It is understood that the article may be formed simultaneously with, preceding, or subsequent to another structure. For example, the microporous article may be co-extruded with a second microporous layer, made with a solid or liquid diluent.

The formed article (before any stretching, which is described below) is generally semi-transparent and/or translucent.

Thereafter the article is typically stretched in at least one direction to provide a network of interconnected micropores throughout the article. The stretching step generally includes biaxially stretching the shaped article. The stretching step provides an area increase in the shaped article of from about 10% to over 1200% over the original area of the shaped article. The actual amount of stretching desired will depend upon the particular composition of the article and the degree of porosity desired.

Stretching may be provided by any suitable device which can provide stretching in at least one direction, and may provide stretching both in that direction and in the other direction. Stretching should be uniform to obtain uniform and controlled porosity. For film or web materials, the material is generally first stretched in the web, machine or longitudinal direction, and then in the cross-web or transverse direction.

The microporous materials of the present invention are preferably dimensionally stabilized according to conventional, well known techniques, such as by heating the stretched sheet, while it is restrained, at a heat stabilizing temperature.

Upon stretching, the polymer domains are pulled apart, permanently attenuating the polymer in zones of continuity, thereby forming fibrils and minute voids between diluent coated domains, and creating a network of interconnected micropores. Such permanent attenuation also renders the article opaque, by drastically increasing the diffusing characteristics of the material. Each air/diluent, diluent/polymer and polymer/air interface is a point or area of reflection and/or refraction, inhibiting the transmission of light and providing an opaque material. Also upon stretching, the diluent either remains coated upon or at least partially surrounds the surface of the resultant polyolefin polymer phase. In most embodiments, the diluent is present between the domains and covers at least a portion of the domain surfaces. The diluent may be present as platelets between polymer domains. Such microstructures are not found in liquid diluent systems or in systems where the diluent has been removed from the material after forming.

It has been determined that for each polymer melt mixture, comprising the polyolefin, solid diluent, and any optional ingredients, an optimum stretch temperature range exists for the first stretching operation. This optimum stretch temperature is dependent upon the particular polyolefin, the specific solid diluent, and the relative amounts of these components. The optimum stretch temperature can be either above or below the melting point of the solid diluent.

If the material is stretched at this optimum stretch temperature or temperature range, the material becomes opaque and microporous. If stretched either at temperatures above or below the optimum range, full opacity is not obtained; indeed, in some embodiments, the material remains generally transparent and is not microporous. This observed trait is much less apparent when liquid diluents are used; with liquid diluents, the material becomes opaque at a broader range of stretching temperatures. For solid diluent containing systems, these stretching temperature ranges are narrow, often less than about 8° C.

An advantage of the present invention is that solid diluents, as opposed to liquid diluents, have little opportunity to swell or soften the polymer during stretching, enabling polymers such as HDPE and TPX to be made microporous without having to extract the diluent. In the case of liquid diluents, diluent extraction can cause swelling and pore collapse of certain types of microporous films such as TPX.

Various examples of stretch temperatures are as follows: a microporous material of HDPE and Polywax 400 polyethylene wax has an optimum stretch temperature of about 60° C., whereas HDPE with IGI 1231 paraffin wax has an optimum stretch temperature of about 63° C.; polypropylene (PP) with Polywax 400 has an optimum stretch temperature of about 77° C., and methylpentene copolymer (TPX) with IGI 1231 has an optimum stretch temperature of about 75° C. It is understood that the specific stretch temperatures will vary based on the polymer, diluent and optional ingredients.

The microporous material may be further modified after stretching by various modes, including the deposition thereon of any one of a variety of compositions, by any one of a variety of known coating or deposition techniques. For example, the microporous material may be coated with metal by vapor deposition or sputtering techniques, or it may be coated with adhesives, aqueous or solvent-based coating compositions, or dyes. Coating may be accomplished by such other conventional techniques such as roll coating, spray coating, dip coating, or any other known coating techniques. The microporous material may be coated, for example, with an antistatic material by conventional wet coating or vapor coating techniques. Specific deposition techniques used will depend upon whether the microporous surface is smooth or patterned and symmetrically or asymmetrically shaped.

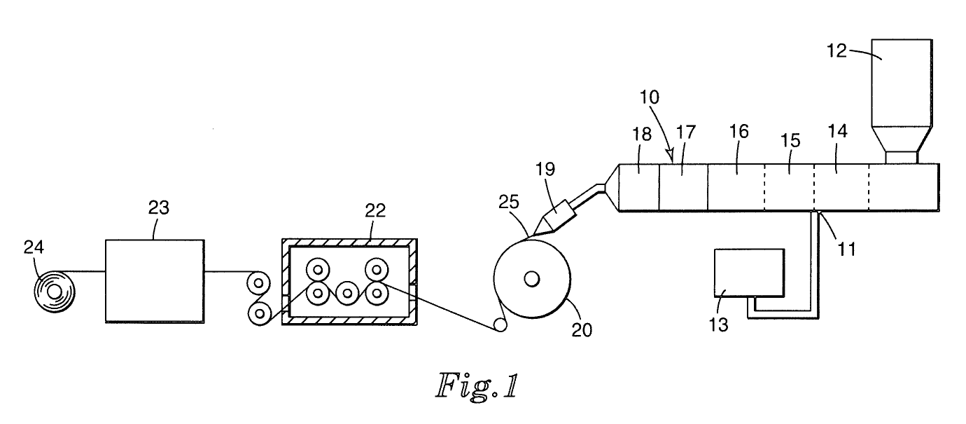

Reference will now be made to the apparatus of FIG. 1 in order to illustrate one preferred method for practicing the present invention. An extruder apparatus 10, having a hopper 12 and various zones, is illustrated. Polyolefin polymer is introduced into hopper 12 of extruder apparatus 10. Solid diluent is melted or softened by device 13 and fed into extruder 10 via a port 11 in the extruder wall between hopper 12 and an extruder exit 17. In other embodiments, port 11 may be positioned proximate hopper 12.

Extruder 10 preferably has at least three zones 14, 15, and 16 which are respectively heated at decreasing temperatures towards extruder exit 17. A slot die 19, having a slit gap of about 25 to about 2000 micrometers, is positioned after the extruder.

It is also suitable to include a suitable mixing device such as a static mixer 18 between extruder exit 17 and slot die 19 to facilitate the blending of the polymer/diluent solution. In passing through extruder 10, the mixture of polymer and diluent is heated to a temperature at or at least about 10° C. above the melting temperature of the melt blend, but below the thermal degradation temperature of the polymer. The mixture is mixed to form a melt blend that is extruded through slot die 19 as a layer 25 onto a quench wheel 20 maintained at a suitable temperature below the crystallization temperature of the polyolefin polymer and the diluent.

The cooled film may then be led from quench wheel 20 to a machine-direction stretching device 22 and a transverse direction stretching device 23, and then to a take-up roller 24 for winding into a roll. Stretching in two directions as done by the apparatus of FIG. 1 is, of course, optional.

A further method of forming a membrane material from the blended melt includes casting the extruded melt onto a patterned chill roll to provide areas where the blend does not contact the chill roll to provide a membrane of substantially uniform thickness having a patterned surface, the patterned surface providing substantially skinless areas having high microporosity and skinned areas of reduced microporosity. Such a method is described in U.S. Pat. No. 5,120,594 (Mrozinski). The membrane material can then be oriented, i.e., stretched.

### EXAMPLES

The following examples are given to show microporous materials which have been made in accordance with the present invention. However, it will be understood that the following examples are exemplary only, and are in nowise comprehensive of the many different types of microporous materials which may be made in accordance with the present invention. Unless otherwise specified, all parts and percentages set forth in the following examples are by weight.

The following test methods were used to characterize the films produced in the examples:

Gurley Air Flow

This test is a measurement of time in seconds required to pass 50 cm³ of air through a film according to ASTM D-726 Method B.

Porosity

A calculated value based on the measured bulk density of the stretched film and the polymer plus solid diluent composite density before stretching using the following equation: Porosity=(1−(bulk density/composite density))×100.

Bubble Point Pore Size

Bubble point values represent the largest effective pore size measured in microns according to ASTM F316-80 and is reported in microns.

% Reflectance

The total reflectance spectra was determined by placing the film sample in a Lambda 900 Spectrometer available from Perkin-Elmer. The output was a percent reflectance for each wavelength over a predetermined range of wavelengths from 300 to 800 nanometers (nm).

Materials Used

The following materials were used to produce the microporous materials:

PETROTHENE 51S07A: Polypropylene homopolymer, 0.8 g/min MFI (ASTM D1238, 230° C./2.16 kg), (from Equistar Chemicals, Houston, Tex.);

FINATHENE 1285: High density polyethylene, 0.07 g/min MI (ASTM D1238, 190° C./2.16 kg) (from Total Petrochemicals, Houston, Tex.);

TPX DX845: polymethylpentene, 9.0 MFI (ASTM D1238, 230° C./2.16 kg), (from Mitsui Plastics, Tokyo, Japan);

MILLAD 3988: Nucleating agent, 3,4-dimethylbenzylidine sorbitol, (from Milliken Chemical Co., Inman, S.C.), (available as a 2.5% concentrate in polypropylene as PPA0642495 from Clariant Corp., Minneapolis, Minn.);

MILLAD HPN-68: Nucleating agent, available as a 5% concentrate in polypropylene as HYPERFORM HI5-5, (from Milliken Chemical Co., Inman, S.C.);

POLYWAX 400: synthetic polyethylene wax, 450 MW, 81° C. melting point, (from Baker Petrolite, Sugar Land, Tex.);

EP-700: synthetic ethylene/propylene copolymer, 650 MW, 96° C. melting point, (from Baker Petrolite, Sugar Land, Tex.);

IGI 1231: refined paraffin wax, 53° C. melting point, (from The International Group, Wayne, Pa.); and

W-835: microcrystalline wax, 76° C. melting point, (from Crompton Corp., Middlebury, Conn.).

### Example 1

A microporous film having 35% polyethylene and 65% low molecular weight polyethylene wax was prepared by the following procedure.

FINATHENE 1285 polyethylene was fed into the hopper of a 40 mm twin-screw extruder. POLYWAX 400 low molecular weight polyethylene wax solid diluent was melted and pumped through a mass flowmeter and then introduced into the extruder through an injection port at a rate to provide a composition of 35% by weight polyethylene and 65% by weight wax solid diluent. No nucleating agent was used. The composition was rapidly heated to 260° C. in the extruder to melt the components after which the temperature was cooled down to and maintained at 204° C. through the remainder of the barrel. The molten composition was pumped from the extruder, through a filter, into a melt pump with a flow rate of 7.3 kg/hr and then via a necktube into a coat hanger slit die. The melt curtain was then cast onto a chrome roll (46° C.) running at 1.5 meters/min. The chrome roll had a knurled pattern on it consisting of 40 raised truncated pyramids per centimeter both axially and radially. The cast film was then stretched in-line with a stretching ratio of 2.25 to 1 in the machine direction using a Killion length orienter, with the final roll of the preheat section set at 59° C., and a stretching ratio of 2.25 to 1 in the transverse direction using a Cellier tenter having zone temperature settings of 60° C. in zones 1-6 and 72° C. in heat setting zones 7-8.

The resulting film was an opaque microporous film having a thickness of 114 microns, a porosity of 60.0%, a pore size of 0.41 microns and a Gurley airflow of 166 sec/50 cm³.

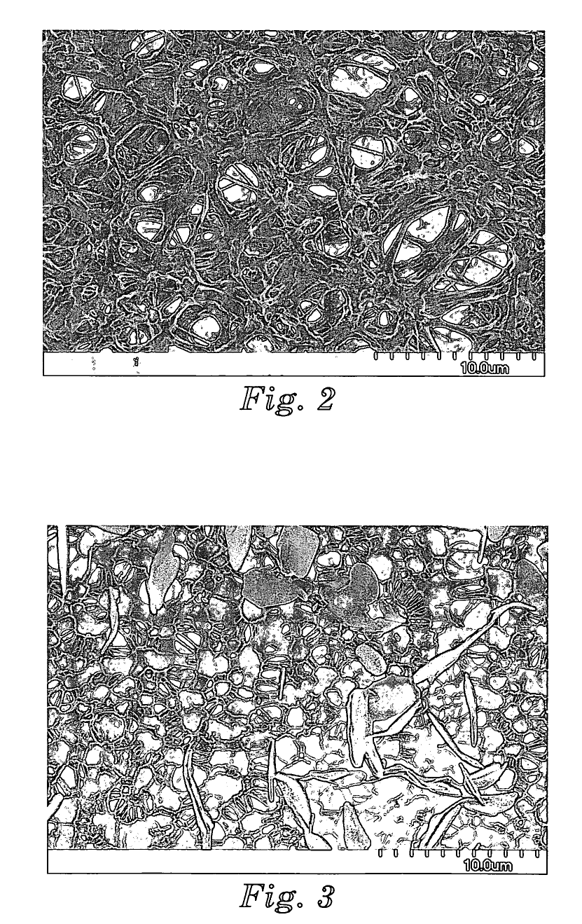

FIG. 2 is a scanning electron micrograph photo at about 4000× of the resultant film. The photo is of the side of the film that was cast against the chrome roll. FIG. 2 shows domains of polymer interconnected with a lacey, polymeric structure.

### Example 2

A microporous film having 33% polyethylene and 67% paraffin wax was prepared as in Example 1, except as below: IGI 1231 paraffin wax was used as the solid diluent at 67% of the total film; a flow rate of 8.2 kg/hr was used; the temperature of the chrome roll was maintained at 21° C.; and a line speed of approximately 2.3 meters/min was used.

The cast film was then stretched in-line with a stretching ratio of 2.25 to 1 in the machine direction using a Killion length orienter with the final roll of the preheat section set at 61° C., and a stretching ratio of 2.25 to 1 in the transverse direction using a Cellier tenter having zone temperature settings of 57° C. for all zones.

The resulting film was an opaque microporous film having a thickness of 119 microns, a porosity of 60.2%, a pore size of 0.34 microns and a Gurley airflow of 160 sec/50 cm³.

### Example 3

A microporous film having 35% polyethylene and 65% microcrystalline wax was prepared as in Example 1, except as below: W-835 microcrystalline wax was used as the solid diluent at 65% of the total film; a flow rate of 3.6 kg/hr was used; the temperature of the chrome roll was maintained at 60° C.; and a line speed of approximately 1.9 meters/min was used.

The cast film was wound into a roll and then in a subsequent step was stretched 2.0 to 1 in the machine direction using a Killion length orienter with the final roll of the preheat section set at 54° C., and a stretching ratio of 2.0 to 1 in the transverse direction using a Cellier tenter having zone temperature settings of 49° C. in zones 1-6 and 43° C. in heat setting zones 7-8.

The resulting film was an opaque microporous film having a thickness of 41 microns, a porosity of 25.8%, a pore size of 0.18 microns and a Gurley airflow of 694 sec/50 cm³.

### Example 4

A microporous film having about 65% polypropylene and about 35% low molecular weight polyethylene wax was prepared as in Example 1, except 51S07A polypropylene was used as the polyolefin polymer and Millad 3988 nucleating agent was used at 0.09%. The resulting composition was about 65% by weight polypropylene and about 35% by weight wax solid diluent, with the 0.09% nucleating agent. A flow rate of 9.1 kg/hr was used. The temperature of the chrome roll was maintained at 67° C., and a line speed of approximately 6.1 meters/min was used.

The cast film was stretched 1.7 to 1 in the machine direction using a Killion length orienter with the final roll of the preheat section set at 77° C., and a stretching ratio of 1.45 to 1 in the transverse direction using a Cellier tenter having zone temperature settings of 77° C. in zones 1-6 and 93° C. in heat setting zones 7-8.

The resulting film was an opaque microporous film having a thickness of 53 microns, a porosity of 44.6%, a pore size of 0.34 microns and a Gurley airflow of 43 sec/50 cm³.

FIG. 3 is a scanning electron micrograph photo at about 4000× of the resultant film. The photo is of the side of the film that was opposite the side that was cast against the chrome roll. FIG. 3 shows the polypropylene material present as spherulitic domains having a partial coating of wax thereon. In addition to the polypropylene surfaces being coated with the wax, excess wax appears as discrete platelet structures between the domains.

### Example 5

A microporous film having about 60% polypropylene and about 40% ethylene/propylene copolymer was prepared as in Example 4, except EP-700 wax was used as the solid diluent at 40% of the total film weight and Millad 3988 nucleating agent was used at 0.075%. A flow rate of 8.2 kg/hr was used. The temperature of the chrome roll was maintained at 66° C. A line speed of approximately 6.1 meters/min was used.

The cast film was stretched 1.7 to 1 in the machine direction using a Killion length orienter with the final roll of the preheat section set at 99° C., and a stretching ratio of 1.8 to 1 in the transverse direction using a Cellier tenter having zone temperature settings of 116° C. in zones 1-6 and 129° C. in heat setting zones 7-8.

The resulting film was an opaque microporous film having a thickness of 38 microns, a porosity of 31.2%, a pore size of 0.34 microns and a Gurley airflow of 71 sec/50 cm³.

### Example 6

A microporous film having about 40% polypropylene and about 60% microcrystalline wax was prepared as in Example 4, except W-835 microcrystalline wax was used as the solid diluent at 60% of the total film weight and Millad 3988 nucleating agent was used at 0.09%. A flow rate of 8.2 kg/hr was used. The temperature of the chrome roll was maintained at 66° C. A line speed of approximately 6.1 meters/min was used.

The cast film was stretched 1.7 to 1 in the machine direction using a Killion length orienter with the final roll of the preheat section set at 66° C., and a stretching ratio of 1.7 to 1 in the transverse direction using a Cellier tenter having zone temperature settings of 74° C. in zones 1-6 and 88° C. in heat setting zones 7-8.

The resulting film was an opaque microporous film having a thickness of 163 microns, a porosity of 46.6%, a pore size of 0.42 microns and a Gurley airflow of 49.5 sec/50 cm³.

### Example 7

A microporous film having about 50% polypropylene and about 50% paraffin wax was prepared as in Example 4, except IGI 1231 wax was used as the solid diluent at 50% of the total film weight and Millad 3988 nucleating agent was used at 0.1%. A flow rate of 9.1 kg/hr was used. The temperature of the chrome roll was maintained at 66° C. A line speed of approximately 2.4 meters/min was used.

The cast film was stretched 1.7 to 1 in the machine direction using a Killion length orienter with the final roll of the preheat section set at 66° C., and a stretching ratio of 1.8 to 1 in the transverse direction using a Cellier tenter having zone temperature settings of 66° C. in zones 1-6 and 77° C. in heat setting zones 7-8.

The resulting film was an opaque microporous film having a thickness of 142 microns, a porosity of 52%, a pore size of 0.55 microns and a Gurley airflow of 26 sec/50 cm³.

### Example 8

A microporous film having about 61% polypropylene and about 39% paraffin wax was prepared as in Example 4, except IGI 1231 paraffin wax was used as the solid diluent at 39% of the total film weight and Millad HPN-68 nucleating agent was used at 0.25%. A flow rate of 3.6 kg/hr was used. The temperature of the chrome roll was maintained at 66° C. A line speed of approximately 2.1 meters/min was used.

The cast film was wound into a roll and then in a subsequent step was stretched 2.0 to 1 in the machine direction using a Killion length orienter with the final roll of the preheat section set at 57° C., and 2.0 to 1 in the transverse direction using a Cellier tenter having zone temperature settings of 55° C. for all zones.

The resulting film was an opaque microporous film having a thickness of 56 microns, a porosity of 45.9%, a pore size of 0.33 microns and a Gurley airflow of 42 sec/50 cm³.

### Example 9

A microporous film having about 42.5% polymethylpentene and about 57.5% paraffin wax was prepared as in Example 1, except DX845 polymethylpentene and IGI 1231 wax were used as the polymer and solid diluent, respectively. A flow rate of 8.2 kg/hr was used. The temperature of the chrome roll was maintained at 79° C. A line speed of approximately 2.5 meters/min was used.

The cast film was stretched 1.75 to 1 in the machine direction using a Killion length orienter with the final roll of the preheat section set at 52° C., and a stretching ratio of 1.9 to 1 in the transverse direction using a Cellier tenter having zone temperature settings of 60° C. for all zones.

The resulting film was an opaque microporous film having a thickness of 81 microns, a porosity of 45%, a pore size of 1.27 microns and a Gurley airflow of 17 sec/50 cm³.

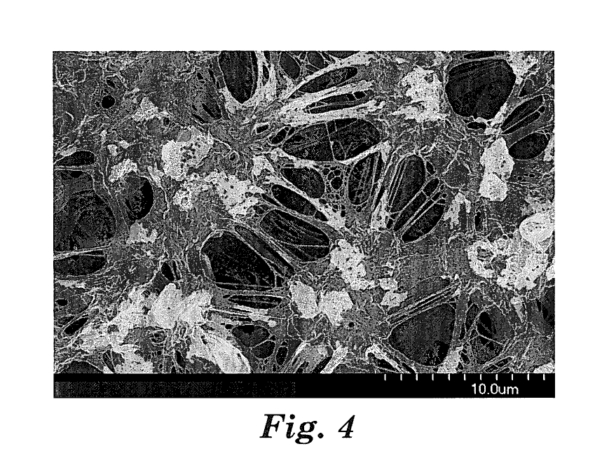

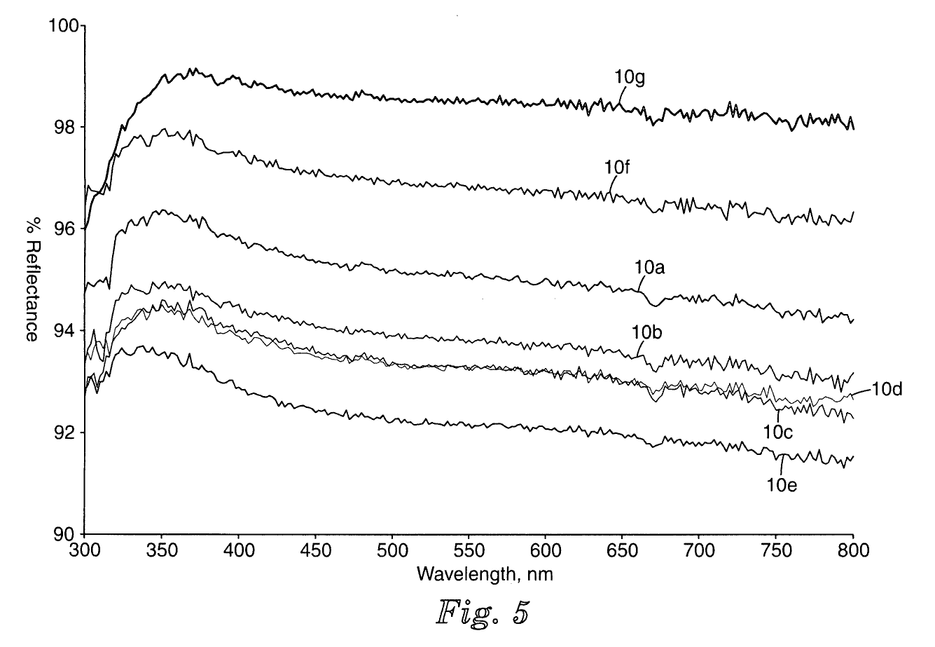

FIG. 4 is a scanning electron micrograph photo at about 4000× of the resultant film. The photo is of the side of the film that was opposite the side cast against the chrome roll.

### Examples 10a-10g

To demonstrate the diffuse reflectance properties of the films of this invention and how stretch ratios and temperatures can affect these properties, a series of films were made similar to that in Example 1.

The high density polyethylene/wax mixture used in Example 1 was rapidly heated to 232° C. in the extruder to melt the components, after which the temperature was cooled down to and maintained at 191° C. through the remainder of the barrel. A flow rate of 14.5 kg/hr was used. The temperature of the chrome roll was maintained at 46° C. and a line speed of approximately 3.0 meters/min was used.

The cast film was stretched in the machine direction using a Killion length orienter at the stretch ratios and temperatures shown in Table 1, and a stretching ratio of 2.65 to 1 in the transverse direction using a Cellier tenter having zone temperatures settings of 63° C. in zones 1-6 and 74° C. in heat setting zones 7-8.

The resulting films were opaque microporous films having a thickness of about 102 microns. These films had a thin, lower porosity skin layer on the side opposite that which contacted the chrome roll. Due to this, the Gurley airflow measurement was greater than 30 minutes after which time the test was discontinued and no results were obtained. Bubble Point Pore Size was not calculated for these samples.

Example 10g was prepared by heat laminating 2 layers of Example 10f together at the final nip prior to entering the tenter oven. The 2 layer laminate was tentered as one coherent film.

The % reflectance of these films measured at a spectrum of wavelengths of incident light is shown in FIG. 5. A total reflectance of at least 92% (over the visible spectrum) is desired; in general, high levels are desired.

As seen in Table 1 and FIG. 5, the reflectance, which is roughly proportional to the porosity of these films could be varied via stretch ratio and stretching temperature. For some examples, the total reflectance was at least 93%, for some at least 96%. The highest reflectance values were obtained by doubling the thickness of the film which was done by lamination rather than direct manufacture due to equipment limitations.

TABLE 1

| | Stretching Temp | | |
|---|---|---|---|
| | (machine direction) | Stretching Ratio | |
| Example | ° C. | (machine direction) | Porosity (%) |
| 10a | 71 | 2.5:1 | 41.5 |
| 10b | 68 | 2.5:1 | 41.1 |
| 10c | 66 | 2.5:1 | 38.0 |
| 10d | 74 | 2.5:1 | 40.0 |
| 10e | 77 | 2.5:1 | 35.9 |
| 10f | 74 | 2.25:1 | 48.0 |
| 10g | 74 | 2.25:1 | — |

Various modifications and alterations of the present invention will be apparent to those skilled in the art without departing from the scope and spirit of this invention, and it should be understood that this invention is not limited to the illustrative embodiments set forth herein. The claims follow.

What is claimed:

1. A microporous material comprising:
(a) a matrix of polyolefin domains interconnected by polyolefin fibrils; and
(b) solid diluent present between the domains, the solid diluent being miscible with the polyolefin at a temperature above the melting temperatures of the polyolefin and the solid diluent and phase separating from the polymer at a temperature below the polymer crystallization temperature.

2. The microporous material of claim 1, wherein the solid diluent is a wax.

3. The microporous material of claim 2, wherein the solid wax is at least one of paraffin wax, microcrystalline wax, and polyethylene wax.

4. The microporous material of claim 1, wherein the solid diluent is a polymer or copolymer.

5. The microporous material of claim 1, wherein the polyolefin is at least one of polyethylene, polypropylene, polybutenes, polyisoprene, polymethylpentene, and copolymers thereof.

6. The microporous material of claim 1, wherein the solid diluent at least partially surrounds the polyolefin domains.

7. The microporous material of claim 1 further comprising a nucleating agent.

8. The microporous material of claim 1 comprising:
(a) 25 to 75 wt-% polyolefin; and
(b) 25 to 75 wt-% solid diluent.

9. The microporous material of claim 8 comprising:
(a) 25 to 50 wt-% high-density polyethylene; and
(b) 50 to 75 wt-% solid diluent.

10. The microporous material of claim 9 comprising at least 55 wt-% polyethylene wax, microcrystalline wax, or paraffin wax.

11. The microporous material of claim 8 comprising:
(a) 30 to 75 wt-% polypropylene; and
(b) 25 to 70 wt-% solid diluent.

12. The microporous material of claim 11 further comprising a nucleating agent.

13. The microporous material of claim 11 comprising about 35 to 40 wt-% polyethylene wax.

14. The microporous material of claim 11 comprising about 35 to 70 wt-% paraffin wax or microcrystalline wax.

15. The microporous material of claim 8 comprising:
(a) 35 to 55 wt-% methylpentene copolymer; and
(b) 45 to 65 wt-% solid diluent.

16. The microporous material of claim 15 comprising at least 45 wt-% paraffin wax.

17. The microporous material of claim 15 comprising 50 to 55 wt-% paraffin wax.

18. The microporous material of claim 1 having a total reflectivity of at least 92%.

19. A diffuise reflective composite article comprising the microporous material of claim 18 laminated to a reflective optical film.

20. An article comprising the microporous material of claim 1.

21. The article of claim 20, wherein the article is a security document.

22. A method of making a microporous article, consisting of:
(a) melt blending to form a solution comprising a melted polyolefin polymer component and a melted solid diluent component, the melted polymer component being soluble in the melted solid diluent component;
(b) forming an article from the melt blended solution;
(c) cooling the article to crystallize the melted polyolefin polymer component and form a matrix of polymer domains and to solidify the melted solid diluent component as solid diluent distributed among the polymer domains; and
(d) creating porosity by stretching the article in at least one direction to separate adjacent polymer domains from each other and to provide a network of interconnected micropores therebetween, the resulting article comprising polyolefin polymer domains at least partially surrounded by solid diluent.

23. The method of claim 22 wherein the step of forming an article from the melt blended solution comprises:
(a) extruding a film from the melt blended solution.

24. The method of claim 22, wherein the step of melt blending to form a solution comprising a melted polyolefin polymer component and a melted solid diluent component, comprises:
(a) melt blending 25 to 75 wt-% polymer component and 25 to 75 wt-% solid diluent component.

25. A method of making a microporous article, comprising:
(a) melt blending to form a solution comprising a melted polyolefin polymer component and a melted solid diluent component, the melted polymer component being soluble in the melted solid diluent component;
(b) forming an article of the melt blended solution;
(c) cooling the article to crystallize the melted polyolefin polymer component and form a matrix of polymer domains and to solidify the melted solid diluent component as wax distributed among the polymer domains; and
(d) creating porosity by stretching the article in at least one direction to separate adjacent polymer domains from each other and to provide a network of interconnected micropores therebetween, the resulting article comprising polyolefin polymer domains at least partially surrounded by solid diluent.

26. The method of claim 25, wherein the step of melt blending to form a solution comprising a melted polyolefin polymer component and a melted solid diluent component, comprises:
(a) melt blending 25 to 75 wt-% polymer component and 25 to 75 wt-% solid diluent component.

27. The method of claim 25, wherein the step of creating porosity by stretching comprises:
(a) creating porosity by stretching within a temperature range of about 8° C.
